(19) United States
(12) Patent Application Publication
(10) Pub. No.: US 2009/0303763 A1
(43) Pub. Date: Dec. 10, 2009

(54) PHOTOVOLTAIC INVERTER

(75) Inventors: Takashi Yuguchi, Osaka (JP); Atsushi Makitani, Osaka (JP); Hajime Yamamoto, Osaka (JP)

Correspondence Address: GLOBAL IP COUNSELORS, LLP, 1233 20TH STREET, NW, SUITE 700, WASHINGTON, DC, 20036-2680, US

(73) Assignee: SANSHA ELECTRIC MANUFACTURING CO., LTD., Higashi-Yodogawa, Osaka (JP)

(21) Appl. No.: 12/162,187

(22) PCT Filed: Jan. 24, 2007
(86) PCT No.: PCT/JP2007/051067

§ 371 Date: Apr. 6, 2009

(30) Foreign Application Priority Data
Jan. 27, 2006 (JP) 2006-018382

(51) Int. Cl. H02M 7/44

(52) U.S. Cl. 363/79

(57) ABSTRACT

A photovoltaic inverter that can respond to changes in temperature and the amount of sunlight and that can automatically start up is provided, which has a simple configuration and is inexpensive. The photovoltaic inverter has a first voltage detection means for detecting an output voltage of a photovoltaic panel; a current detection means, a control means and a driving means. It further has a model voltage storage means for storing a model voltage table of inverter start-up kick voltages produced based on variation values of an amount of sunlight, a model voltage read-out means, a second voltage detection means for detecting an inverter start-up kick voltage, and an inverter start-up control means.

### CROSS-REFERENCE TO THE RELATED APPLICATIONS

This application claims priority to Japanese Patent Application No. 2006-018382 and International Patent Application No. PCT/JP2007/051067. The entire disclosure of Japanese Patent Application No. 2006-018382 and International Patent Application No. PCT/JP2007/051067 is hereby incorporated herein by reference.

### TECHNICAL FIELD

The present invention relates to photovoltaic inverters, and more specifically to the control of such an inverter.

### BACKGROUND ART

Patent Document 1 is a technical document relating to the output control of a photovoltaic generator. Paragraph (0006) of Patent Document 1 states that “the maximum power that can be retrieved from solar cells changes as the temperature or the amount of sun light changes, and without taking further measures, it is not possible to retrieve the maximum power efficiently from solar cells.” Paragraph (0002) states that “in the solar cell generating electricity when being irradiated with sunlight, when the amount of sunlight onto the solar cell as well as the temperature are constant, the output voltage Vs drops sharply and becomes zero, if the output current Is is increased above a certain constant value Iop as shown in FIG. 6, which shows the relationship between the output current and the output voltage of the solar cell. The maximum output power Pmax of a solar cell having such characteristics occurs when the output current is Iop, and is given by the product of this current Iop and the output voltage Vop at that time. A solar cell panel is made by fitting 40 to 50 of such solar cells on one panel and connecting them in series or in parallel.”

Paragraph (0003) states that “in such a solar cell panel, when the temperature is kept constant and the amount of sunlight is varied, then the relationship between the output current Is and the output voltage Vs changes from curve A1 to curve A2 when the amount of sunlight decreases, as shown for example by the solid lines in FIG. 7, and accordingly also the maximum output point changes from a1 to a2. As a result, the maximum output point changes as indicated by curve “a”, which is represented by a long-short-dashed line. Here, FIG. 7 is a diagram illustrating the state when the relation between the output current and the output voltage of a solar cell changes due to a change in the amount of sunlight or the temperature.”

Paragraph (0004) states that “in this solar cell panel, when the amount of sunlight is kept constant and the temperature is varied, then the relationship between the output current Is and the output voltage Vs changes from curve B1 to curve B2 when the temperature increases, as shown by the broken lines in FIG. 7, and accordingly also the maximum output point changes from b1 to b2. As a result, the maximum output point changes as indicated by curve “b”, which is represented by a long-short-short-dashed line. Due to these characteristics, as the temperature or the amount of sunlight changes, also the maximum power than can be retrieved from the solar cells changes, and there is the problem that (1) unless further measures are taken, the maximum power cannot be retrieved efficiently from the solar cells.” The invention of Patent Document 1 is to solve this problem.

According to the invention of patent Document 1, an optimum output voltage value generating the maximum power that is retrieved from the solar cell is detected and held, and taking this held optimum output voltage value as a reference signal, a voltage control means is controlled for a predetermined period of time. After the predetermined period of time has passed, the process of detecting and holding the optimum output voltage value, and controlling the voltage control means for a predetermined time, taking this held optimum output voltage value as a reference value, is repeated, so that even when there is a change in the amount of sunlight or the temperature, it is ordinarily possible to retrieve the maximum power from the solar cell.

However, the optimum output voltage value obtained by holding a voltage near a2 from the time of sunset of the previous day (that is, a voltage lower than V2) will be stored as the reference signal. On the next morning, the detected voltage is still not higher than V2 at the start-up within a short period of time directly after sunrise, so that the start-up control of the inverter leads to repeated turning on and off of the inverter, and a smooth start-up is not possible.

### [Patent Document 1] JP H06-214667A

### SUMMARY OF THE INVENTION

When the amount of sunlight is reduced, there is a change from curve A1 to curve A2 as shown by the solid lines in FIG. 7. Problem 2 is that in cases in which the amount of sunlight on the following day is lower than that on the previous day, a manual setting operation was conventionally required every time the inverter is to be started. There is a need for a technique allowing automatic inverter start-up in unmanned facilities, in which the start-up command is corrected for variations in sunlight and temperature.

To solve Problem 2, the inventors deduced that in case that the inverter is to be operated automatically on curve A1 in FIG. 7 for example, if it were possible to shift from point As on curve A1 to point Ass on curve A2 and change the setting value, then an automatic start-up would be possible.

It is defined that “the electric signal serving as a trigger for sending the inverter start-up command” as the “inverter start-up kick voltage”. In accordance with a first aspect of the present invention, a photovoltaic inverter has a first voltage detection means for controlling the inverter output characteristics, a current detection means, a control means and a driving means, wherein the photovoltaic inverter further has a model voltage storage means for storing a variation value table of inverter start-up kick voltages produced based on sample values of an amount of sunlight that changes incessantly, a model voltage read-out means, a second voltage detection means for detecting an inverter start-up kick voltage, and an inverter start-up control means.

In accordance with a second aspect of the present invention a photovoltaic inverter has an inverter controlling an output voltage of a photovoltaic panel and supplying the output voltage to a load, a driving means for driving said inverter, a power detection means for detecting the output power of the photovoltaic panel where the power detection means is constituted by a first voltage detection means for detecting an output voltage of the photovoltaic panel and a current detection means for detecting an output current of the photovoltaic panel, and a power control means for applying a PWM control signal to the driving means. The photovoltaic inverter further has a model voltage storage means for storing a model voltage table of inverter start-up kick voltages produced based on variation values of an amount of sunlight, a model voltage read-out means, a second voltage detection means for detecting a kick voltage for inverter start-up, and an inverter start-up control means.

In accordance with a third aspect of the present invention, a photovoltaic inverter has an inverter controlling an output voltage of a photovoltaic panel and supplying the output voltage to a load, a driving means for driving said inverter, a power detection means for detecting the output power of the photovoltaic panel where the power detection means is constituted by a first voltage detection means for detecting an output voltage of the photovoltaic panel and a current detection means for detecting an output current of the photovoltaic panel, and a power control means for applying a PWM control signal to the driving means. The load is connected to the inverter via a contactless switching element, and the photovoltaic inverter further has a model voltage storage means for storing a model voltage table of inverter start-up kick voltages produced based on variation values of an amount of sunlight, a model voltage read-out means, a second voltage detection means for detecting an inverter start-up kick voltage, and an inverter start-up control means. The contactless switching element is an element that can connect or disconnect alternating current, such as a triac or an anti-parallel connected thyristor, which has a control electrode and a main current conduction electrode, and which has the operative effect of causing main current conduction only when the control electrode receives a signal that is supplied from an inverter start-up control means.

In a photovoltaic inverter according to any one of the first to the third aspect of the present invention, in a first format of the model voltage table according to a fourth and fifth aspect of the present invention, a table is devised, taking as orthogonal axes a temperature axis and a time axis taking seasonal variation values of the inverter start-up kick voltage produced based on the seasonal variations of the sunlight amount as model voltages, and the model voltage table of the second format is a model voltage table in which the element of seasonal variations is factored in and that can be read out in chronological order.

In accordance with the fourth aspect of the present invention, in the photovoltaic inverter according to any one of the first to third aspect, seasonal variation values of the inverter start-up kick voltage produced based on seasonal variation values of an amount of sunlight are taken as the model voltage in the model voltage table of the first format, and the model voltage table is a model voltage table in which a time axis serves as the X-axis (or Y-axis) and temperature serves as the Y-axis (or X-axis).

In accordance with the fifth aspect of the present invention, in the photovoltaic inverter according to any one of the first to the third aspect, the model voltage table of the second format, which is a model voltage table in which the element of seasonal variations is factored in and that can be read out in chronological order, is a model voltage table in which the element of seasonal variations is factored in and that can be read out in chronological order.

This model voltage table is obtained by storing a gradual variation model voltage VM in which the element of seasonal variations is factored in and that can be read out in chronological order and a short day model voltage VML to enable daily corrections and arranging them as a table.

In accordance with a sixth aspect of the present invention, in a photovoltaic inverter according to the fifth aspect, the gradual variation model voltage VM and the short day model voltage VML are stored and arranged into a model voltage table, the VM table and the VML table are read out and combined, and a model voltage table is obtained for setting the kick voltage of that day, taking all times of all seasons are taken as model voltages.

In accordance with the seventh aspect of the present invention, a photovoltaic system has a solar cell, an inverter connected to the solar cell, a control unit controlling the inverter based on a voltage and a current between the solar cell and the inverter, and a start-up command signal providing unit that sends a start-up command signal to the control unit, using a model voltage table of inverter start-up kick voltages that are produced based on variation values of an amount of sunlight.

With this system, it is possible to automatically start the inverter in accordance with variations in the amount of sunlight.

In accordance with a eight aspect of the present invention, in a photovoltaic system according to the seventh aspect, the start-up command signal providing unit detects the voltage between the solar cell and the inverter at a time when operation of the inverter starts, and this voltage can be stored in the model voltage table as the inverter start-up kick voltage.

With this system, the start-up of the inverter becomes smooth, due to a learning function.

In accordance with a ninth aspect of the present invention, in a photovoltaic system according to the seventh or eighth aspect, the start-up command signal providing unit has a storage unit storing the model voltage table, a voltage detection unit detecting the voltage between the solar cell and the inverter, a read-out unit reading out from the model voltage table an inverter start-up kick voltage that matches a detection result of the voltage detection unit, and a start-up control unit that sends a start-up command signal to the control unit, based on the inverter start-up kick voltage that has been read out.

In accordance with the tenth aspect of the present invention, in the photovoltaic system according to any one of the seventh to ninth aspect, in the model voltage table, the inverter start-up kick voltages are set in correlation with information that influences a variation in the amount of sunlight, such as the time of day, the month to which the day belongs or the season.

### BRIEF DESCRIPTION OF THE DRAWINGS

FIG. 1 is an overall circuit diagram including an inverter according to one embodiment of the present invention.

FIG. 2 is an overall circuit diagram including an inverter according to another embodiment of the present invention.

FIG. 3 is a circuit diagram including a conventional inverter as described in Patent Document 1.

FIG. 4 is a diagram showing the relationship between the output current and the output voltage of a photovoltaic panel using a working example of the present invention.

FIG. 5 is an operation diagram of one embodiment of the present invention.

FIG. 6 is a diagram showing the relationship between the output current and the output voltage of a photovoltaic panel using a working example of the present invention.

FIG. 7 is a diagram illustrating the state when the relation between the output current and the output voltage of the solar cell used in a working example of the present invention changes due to a change in the amount of sunlight or the temperature.

### DETAILED DESCRIPTION OF THE PREFERRED EMBODIMENTS

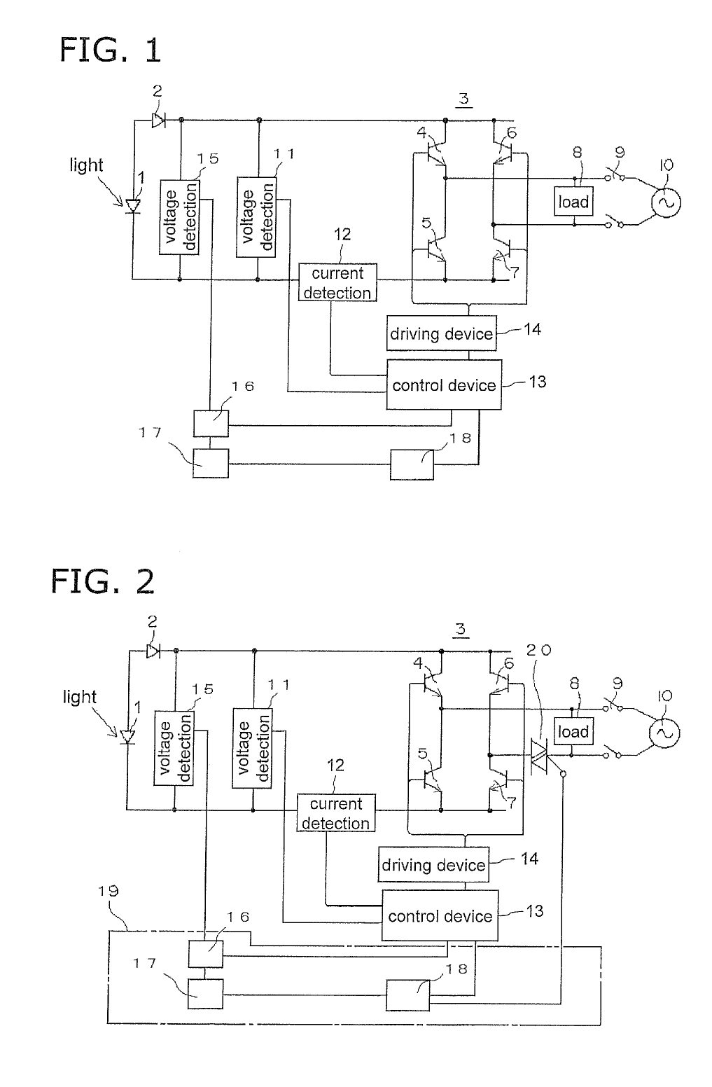

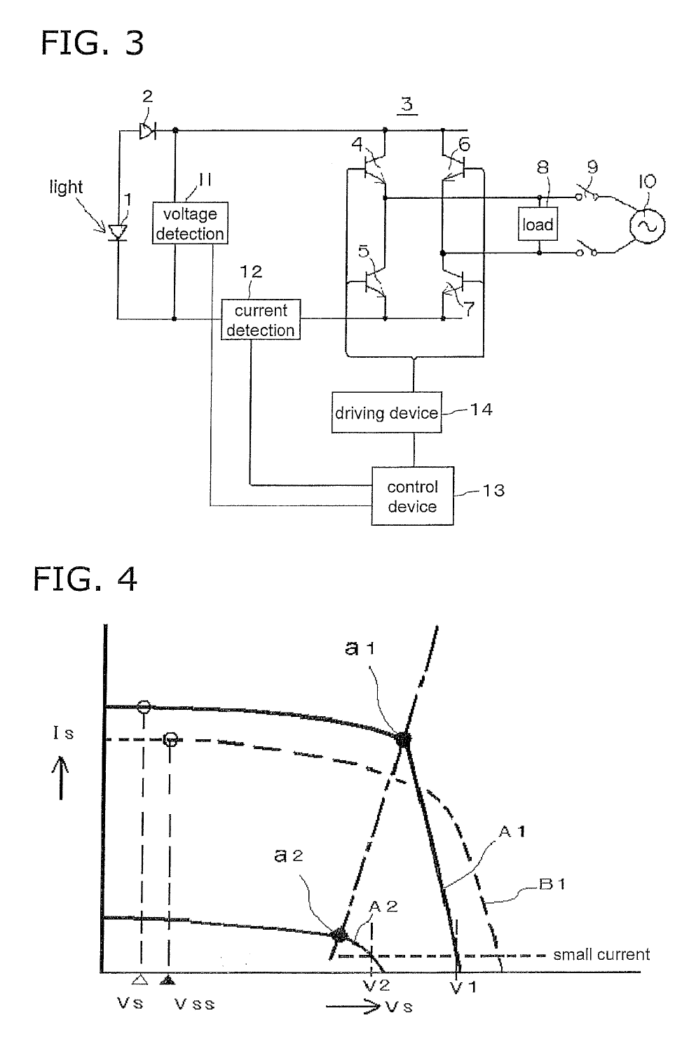

The following explanations make reference to FIG. 1, which is an overall circuit diagram including an inverter according to one embodiment of the present invention. Numbers that are the same as in FIG. 2, which is an overall circuit diagram showing an inverter according to another embodiment of the invention, or in FIG. 3, which is a circuit diagram including a conventional inverter described in Patent Document 1, denote like elements. This working example includes a photovoltaic panel 1, which is connected via a protection diode 2 to the input side of an inverter 3. This inverter 3 is constituted by switching elements 4 to 7, such as IGBTs or other transistors. The output side of the inverter 3 is connected to a load 8. This load 8 is connected via switches 9 to a commercial AC power source 10. The switches 9 are closed when there is a reverse power flow from the photovoltaic panel 1 to the commercial AC power source 10. In the overall circuit diagram of FIG. 2, which includes an inverter according to another embodiment of the present invention, the load 8 is connected via a contactless switching element 20 to the output side of the inverter 3. This switching element 20 has the advantage that it becomes possible to switch the state of the inverter at start-up quickly between load and no-load by applying to its control electrode a connect/disconnect signal from a start control means 18.

On the input side of the inverter 3, a first voltage detector 11 is provided between plus and minus, and detects the voltage that is applied by the photovoltaic panel 1 to the inverter 3. Similarly, a current detector 12 is arranged serially between the inverter 3 and the photovoltaic panel 1, and detects the current that is supplied from the photovoltaic panel 1 to the inverter 3. The detected voltage and the detected current are supplied to a control device 13. This control device 13, which carries out voltage control of the inverter based on the detected voltage and the detected current is a circuit as disclosed, for example, in JP H06-214667A. The control device 13 supplies a driving control signal to the driving device 14. The driving device 14 controls the supplied power in such a manner that the DC voltage of the photovoltaic panel 1 is switched to AC and becomes constant with respect to the load 8, by controlling the switching elements 4 to 7 of the inverter 3 in response to this driving control signal.

The details regarding the conventional inverter control explained below are the same as in Patent Document 1, so that duplicated explanations of such details are omitted and only the aspects necessary for the overall understanding are explained. The control device 13 of FIG. 1 has a multiplier that multiplies the detected voltage with the detected current. The multiplication output of the multiplier represents the output power that is retrieved from the photovoltaic panel 1. This multiplier, the first voltage detector 11 and the current detector 12 constitute a power detection means. The signal representing this output power is voltage-divided with resistors, the voltage-divided signal is supplied to a comparator, and the output of the comparator is fed to a hold circuit that holds and outputs the voltage signal of directly previously to when the output of the comparator changes from “0” to “1”. The hold output is supplied to an error amplifier, to which also the voltage-divided signal is supplied. The discrepancy between the two is amplified and the error amplifier is supplied to the driving circuit. When sunlight is irradiated onto the photovoltaic panel, the solar cells excite a voltage, which is supplied to the inverter, voltage-controlled by the inverter, and supplied to the load. The details of this are described in Patent Document 1.

In the overall circuit diagram of FIG. 2, which includes an inverter according to another embodiment of the present invention, the load 8 is connected via a contactless switching element 20, such as a thyristor, to the output side of the inverter 3. The load 8 is connected via switches 9 to the commercial power source 10. The switches 9 are closed to cause a reverse power flow from the solar panel 1 to the commercial power source 10. Since the load is connected or disconnected with this contactless switching element 20, there is the advantage that start-up is possible while checking the voltage of the inverter 3 in the momentary loadless operation due to momentary disconnection, and not with the load still connected to the inverter 3, as in the conventional circuit diagram of FIG. 3.

In order to smoothly carry out the start-up of the inverter according to the present invention as shown in FIG. 1 and FIG. 2, the output voltage of the photovoltaic panel is detected with a second voltage detection means 15 as a trigger for the start-up command, moreover a memory means 16, a read-out means 17 and a start-up control means 18 form a PV learning means 19, and a PV learning function is implemented.

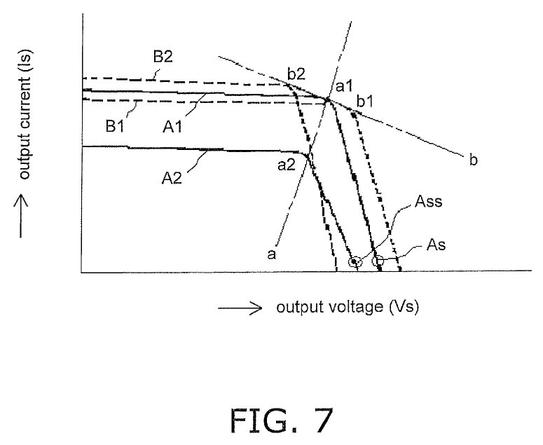

FIG. 7 is a diagram illustrating the state when the relation between the output current and the output voltage of the photovoltaic panel used in the working example of the present invention changes due to a change in the amount of sunlight or the temperature. In this photovoltaic panel, when the temperature is kept constant and the amount of sunlight is changed, the relation between the output current Is and the output voltage Vs changes from curve A1 to A2, indicated by solid lines, as the amount of sunlight decreases. Accordingly, also the point of maximum output changes from a1 to a2. As a result, the point of maximum output changes as indicated by curve “a”, which is represented by a long-short-dashed line.

Referring to FIG. 4, only those aspects in FIG. 7 that are necessary for explaining the present invention are explained. The DC voltage when a current value that is close to no load is output changes from V1 to V2 as there is a change from curve A1 to A2. The voltage value at noon is V1 and directly before sunset it is V2. The second voltage detection means 15 in FIGS. 1, 2 detects these voltages. When these voltages are detected, the model voltage read-out means 17 reads out a matching value V2 from the voltage table in the model voltage storage means 16. At the moment when, during the operation of the inverter, V1 is detected and V2 is detected at sunset, the model voltage read-out means 17 performs a read-out, and the matching value V2 of these is sent as a signal to the start-up control means 18, and when the PCM control of the control means is narrowed down, the output of the inverter is stopped.

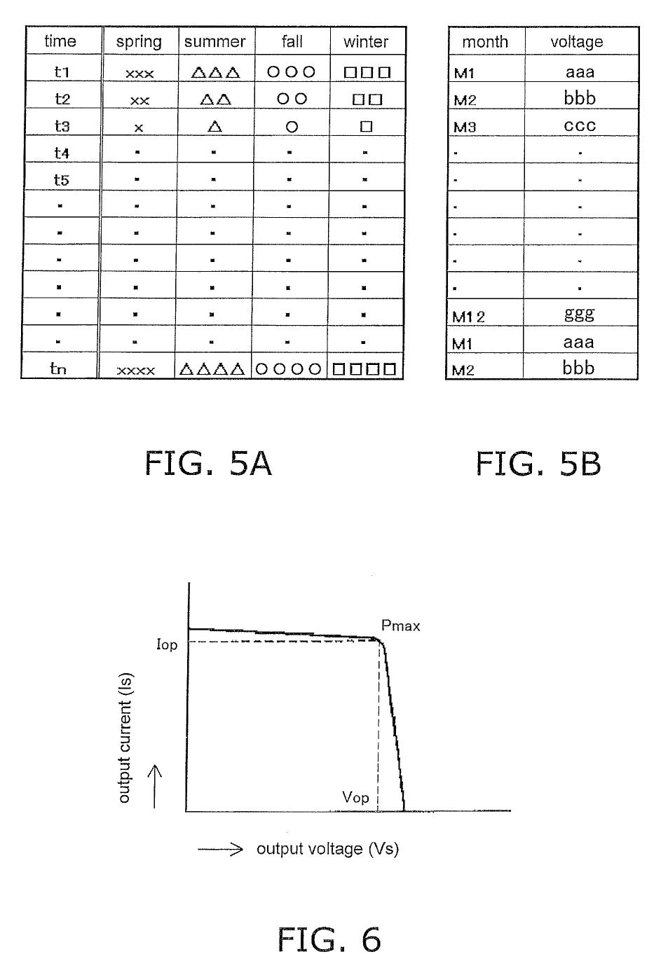

At the next morning, the voltage V1 is detected, and the model voltage read-out means 17 sends the value V1 matching the detected voltage to the start-up control means 18, and increases the output of the inverter by widening the conduction width of the PCM control of the control means, that is, when starting the operation, the voltage V1 is set as a start-kick voltage, and stored in the voltage table of FIG. 5. In FIG. 4, since, when the temperature is low, a given operating voltage Vs shifts to Vss on the curve B1, this, too, is stored in the voltage table of FIG. 5, and Vss is stored at the point of the Y-axis for temperature, so that it is possible to address and correct temperature changes. FIG. 5 shows operation diagrams of a working embodiment of a model voltage table.

Of the operation diagrams shown in FIG. 5, FIG. 5A shows a first format of a model voltage table, in which seasonal variation values of the inverter start-up kick voltage that are produced based on the seasonal variation of the amount of sunlight are taken as a model voltage, and arranged in a table with a temperature axis and a time axis as orthogonal axes.

A model voltage table of the second format, which is a simplified model voltage table in which the element of seasonal variation is factored in and which can be read out in chronological order, is shown in FIG. 5B. The Y-axis extends from January to December, and continuing the read-out with January after December, it can be carried on endlessly.

The simplified model voltage table was devised as two model voltage tables in which gradual variation model voltages VM that factor in the element of seasonal variations in and that can be read out in chronological order and short day model voltages VML to enable daily corrections are stored.

In the first format, the temperature axis of FIG. 6A is the X-axis. This X-axis is divided into four sections, namely spring, summer, fall and winter, corresponding to the four seasons. Based on the seasonal variations recorded at the place where the device is set up, the produced inverter start-up kick voltage XXX etc. is recorded as the model voltages, and PV learning is performed.

The following is an explanation of the operation of the automatic start-up of the inverter.

When the start-up kick voltage XX for the time t2 in the morning is read out at the section “spring”, the voltage V1 is detected in the morning with the second voltage detection means 15, the model voltage read-out means 17 sends the value V1 matching the detected voltage xx as a signal to the start-up control means 18, the output of the inverter is increased by broadening the conduction width of the PCM control of the control means, and thus the operation is started. At the same time, the voltage V1 is set as the start-up kick voltage, and stored in the voltage table.

When the temperature is high, the kick voltage AA for the time t2 is read out from the section “summer”, and the operation is started. At the same time, the voltage V1 of the curve A1 is set as the start-up kick voltage and stored in the voltage table. On the next day, this voltage V1 is taken as the kick voltage, so that when the temperature rises, there is a transition from the curve B1 to the curve A1 on the next day and the voltage B1 shifts in a direction of lower kick voltages on the curve B1 (of the previous day), but the operation is started such that the second voltage detection means 15 will not perform a faulty voltage detection, or in other words, a “learning” function is implemented.

Reading out the gradual variation model voltage (VM table) and the short day model voltage (VML table), combining them and recording all times of all seasons as model voltages is advantageous for automatically setting the kick voltage for the start-up on the actual day in a precise manner.

As explained above, with the present invention, even when there is a change in the amount of sunlight or the temperature at the time of the start-up of the inverter, a model voltage table, in which the element of the seasonal variations is factored in the signal values serving as a reference for sending out a start-up command signal and arranged as a table. Since the storage means for storing the model voltage table, the read-out means and the start-up control means are provided, there is, at the start-up time of the inverter, start-up is performed at Ass of the curve A2 for weaker sun-light irradiation, and once the sun-light irradiation has stabilized, the same power is output as in the case of starting up at As of curve A1, without such trouble as that the inverter is repeatedly turned on and off.

### INDUSTRIAL APPLICABILITY

With the power source device according to the present invention, photovoltaic equipment that can be distributed easily to minor consumers, such as individual households, can be manufactured inexpensively. As it becomes more widespread, it becomes unnecessary to build power plants for peak demand during power scarcities in summer, thereby contributing to society by saving natural resources and achieving a valuable industrial contribution.

1. A photovoltaic inverter comprising a first voltage detection means; a current detection means; a control means and a driving means,
wherein the photovoltaic inverter further comprises a model voltage storage means for storing a seasonal variation value table of inverter start-up kick voltages produced based on variation values of an amount of sunlight; a model voltage read-out means; a second voltage detection means for detecting an inverter start-up kick voltage; and an inverter start-up control means.

2. A photovoltaic inverter comprising an inverter controlling an output voltage of a photovoltaic panel and supplying the output voltage to a load; a driving means for driving said inverter; a power detection means for detecting the output power of the photovoltaic panel, the power detection means being constituted by a first voltage detection means for detecting an output voltage of the photovoltaic panel and a current detection means for detecting an output current of the photovoltaic panel; and a power control means for applying a PWM control signal to the driving means;
wherein the photovoltaic inverter further comprises a model voltage storage means for storing a model voltage table of inverter start-up kick voltages produced based on variation values of an amount of sunlight; a model voltage read-out means; a second voltage detection means for detecting a kick voltage for inverter start-up; and an inverter start-up control means.

3. A photovoltaic inverter comprising an inverter controlling an output voltage of a photovoltaic panel and supplying the output voltage to a load; a driving means for driving said inverter; a power detection means for detecting the output power of the photovoltaic panel, the power detection means being constituted by a first voltage detection means for detecting an output voltage of the photovoltaic panel and a current detection means for detecting an output current of the photovoltaic panel; and a power control means for applying a PWM control signal to the driving means; wherein the load is connected to the inverter via a contactless switching element that is conductive only when its control electrode receives a signal that is supplied from an inverter start-up control means;
wherein the photovoltaic inverter further comprises a model voltage storage means for storing a model voltage table of inverter start-up kick voltages produced based on variation values of an amount of sunlight; a model voltage read-out means; a second voltage detection means for detecting an inverter start-up kick voltage; and an inverter start-up control means.

4. The photovoltaic inverter according to claim 1, wherein seasonal variation values of the inverter start-up kick voltage produced based on seasonal variation values of an amount of sunlight are taken as the model voltage, and the model voltage table is a model voltage table in which a time axis serves as the X-axis and temperature serves as the Y-axis.

5. The photovoltaic inverter according to claim 1, wherein the model voltage table is a model voltage table in which a gradual variation model voltage VM in which the element of seasonal variations is factored in and that can be read out in chronological order and a short day model voltage VML to enable daily corrections are stored and arranged as a table.

6. The photovoltaic inverter according to claim 5, wherein the gradual variation model voltage VM and the short day model voltage VML are stored and arranged into a model voltage table, the VM table and the VML table are read out and combined, and a model voltage table is obtained for setting the kick voltage of that day, taking all seasons and all times as model voltages.

7. A photovoltaic system, comprising:
a solar cell;
an inverter connected to the solar cell;
a control unit controlling the inverter based on a voltage and a current between the solar cell and the inverter; and
a start-up command signal providing unit that sends a start-up command signal to the control unit, using a model voltage table of inverter start-up kick voltages that are produced based on variation values of an amount of sunlight.

8. The photovoltaic system according to claim 7, wherein the start-up command signal providing unit detects the voltage between the solar cell and the inverter at a time when operation of the inverter starts, and this voltage can be stored in the model voltage table as the inverter start-up kick voltage.

9. The photovoltaic system according to claim 7, wherein the start-up command signal providing unit comprises a storage unit storing the model voltage table; a voltage detection unit detecting the voltage between the solar cell and the inverter; a read-out unit reading out from the model voltage table an inverter start-up kick voltage that matches a detection result of the voltage detection unit; and a start-up control unit that sends a start-up command signal to the control unit, based on the inverter start-up kick voltage that has been read out.

10. The photovoltaic system according to claim 7, wherein, in the model voltage table, the inverter start-up kick voltages are set in correlation with information that influences a variation in the amount of sunlight, such as the time of day, the month to which the day belongs or the season.

11. The photovoltaic inverter according to claim 2, wherein seasonal variation values of the inverter start-up kick voltage produced based on seasonal variation values of an amount of sunlight are taken as the model voltage, and the model voltage table is a model voltage table in which a time axis serves as the X-axis and temperature serves as the Y-axis.

12. The photovoltaic inverter according to claim 3, wherein seasonal variation values of the inverter start-up kick voltage produced based on seasonal variation values of an amount of sunlight are taken as the model voltage, and the model voltage table is a model voltage table in which a time axis serves as the X-axis and temperature serves as the Y-axis.

13. The photovoltaic inverter according to claim 2, wherein the model voltage table is a model voltage table in which a gradual variation model voltage VM in which the element of seasonal variations is factored in and that can be read out in chronological order and a short day model voltage VML to enable daily corrections are stored and arranged as a table.

14. The photovoltaic inverter according to claim 3, wherein the model voltage table is a model voltage table in which a gradual variation model voltage VM in which the element of seasonal variations is factored in and that can be read out in chronological order and a short day model voltage VML to enable daily corrections are stored and arranged as a table.

15. The photovoltaic system according to claim 8, wherein the start-up command signal providing unit comprises a storage unit storing the model voltage table; a voltage detection unit detecting the voltage between the solar cell and the inverter; a read-out unit reading out from the model voltage table an inverter start-up kick voltage that matches a detection result of the voltage detection unit; and a start-up control unit that sends a start-up command signal to the control unit, based on the inverter start-up kick voltage that has been read out.

16. The photovoltaic system according to claim 8, wherein, in the model voltage table, the inverter start-up kick voltages are set in correlation with information that influences a variation in the amount of sunlight, such as the time of day, the month to which the day belongs or the season.

17. The photovoltaic system according to claim 9, wherein, in the model voltage table, the inverter start-up kick voltages are set in correlation with information that influences a variation in the amount of sunlight, such as the time of day, the month to which the day belongs or the season.
